(19) United States
(12) Patent Application Publication
(10) Pub. No.: US 2024/0403153 A1
(43) Pub. Date: Dec. 5, 2024

(54) AUGMENTING SOURCE CODE REPRESENTATION MODELS WITH ABSTRACT SYNTAX TREES USING TREE TRAVERSAL ALGORITHMS

(71) Applicant: Oracle International Corporation, Redwood Shores, CA (US)

(72) Inventors: Arno Schneuwly, Effretikon (CH); Aneesh Dahiya, Zurich (CH); Felix Schmidt, Baden-Dattwil (CH)

(21) Appl. No.: 18/205,076

(22) Filed: Jun. 2, 2023

(51) Int. Cl. G06F 11/00; G06N 3/042

(52) U.S. Cl. CPC G06F 11/006; G06N 3/042

(57) ABSTRACT

In an embodiment, a computer generates a multi-sequence vector that contains a plurality of distinct sequences of distinct nodes of a parse tree of source logic. Based on the multi-sequence vector, the computer trains a logic encoder. After training and in a production environment, the logic encoder infers a fixed-size encoded logic from new source logic. Based on the fixed-size encoded logic, the new source logic is detected as anomalous by an anomaly detector. Both of the logic encoder and the anomaly detector are machine learning models and, herein, they may be separately trained. In an embodiment, the logic encoder is based on a natural language processing (NLP) language model architecture such as bidirectional encoder representations from transformers (BERT), or novel training herein may be self-supervised according to skip-gram for use with an unlabeled training corpus.

### FIELD OF THE INVENTION

The present invention relates to natural language processing (NLP). To facilitate detection of anomalous database statements, a logic encoder is trained within a neural network to infer a fixed-size encoded statement from a source statement.

### BACKGROUND

State of the art feature encoding cannot densely encode a logical tree without losing important information, and a sparse encoding wastes space. Whether dense or sparse, an encoding of a logical tree may be difficult for a machine learning model to analyze and recognize, and inference accuracy based on a tree may be low (i.e. poor) with a state of the art encoding.

State of the art feature encoding of a tree may entail lossy flattening by which important tree topology details may be lost (i.e. not encoded). For example, the state of the art may decompose a logical tree into an array of small tree fragments also known as dependencies. So difficult is feature engineering for a linguistic dependency tree that best of breed natural language processing (NLP) language model BERT (bidirectional encoder representations from transformers) forgoes parsing and instead accepts lexical tokens. However due to not parsing, BERT's accuracy is suboptimal, which may decelerate training or decrease accuracy of production inferencing.

### BRIEF DESCRIPTION OF THE DRAWINGS

In the drawings:

FIG. 1A is a block diagram that depicts an example training computer that uses a natural language processing (NLP) skip-gram task to train a logic encoder in an artificial neural network (ANN) to infer a fixed-size encoded logic from source logic;

FIG. 1B is a block diagram that depicts an example deployment computer that uses an already trained logic encoder in a production environment to infer a fixed-size encoded logic from new source logic;

FIG. 2 is a flow diagram that depicts an example computer process to train and deploy, into production, a logic encoder to infer a fixed-size encoded logic from new source logic;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein is novel natural language processing (NLP) for security of a database or a web browser. To facilitate detection of an anomalous database statement or browser script, an artificial neural network (ANN) is trained to infer an encoded logic from a source logic or statement.

A source code model (SCM) herein may be based on a natural language model architecture, and the language model is extended with additional information such as an abstract syntax tree (AST) of the logic or statement. This provides a way to ingest structural (i.e. topological) information such as dependencies between nodes of an AST. An ordered sequence of nodes is generated from a tree traversal algorithm capturing part of the original relationships between tree nodes. By multiple distinct traversal algorithms, multiple distinct sequences for a same AST are generated. Each sequence incompletely encodes the topology of the AST and loses different topological details. The combination of the multiple distinct sequences ensures that most or all details lost in one sequence are instead captured in the other sequence(s). In that way, the AST encoding is high fidelity (i.e. accurate), which increases training accuracy that may accelerate training.

One novelty of this invention is to up-sample by concatenating multiple tree traversal token sequences into one input token sequence to train a logic language model. As discussed herein, the logic language model may be based on an NLP model architecture such as FastText or bidirectional encoder representations from transformers (BERT). Depending on the embodiment, up-sampling occurs during training and does or does not occur during production inferencing.

This novel approach has at least the following advantages.
Versatility: Up-sampling can be retrofitted for training a (e.g. opaque, black box) language model that was not designed for up-sampling. The approach may be used with state of the art NLP models which accept only a token sequence as an input.
Lightweight: The method is lightweight because tree traversal and linearization are low complexity operations. Being lightweight accelerates training and conserves memory while training.
Information Gain: The method combines multiple tree linearization strategies and thus captures more syntactic structure despite the information losses induced by linearization.
Arbitrary Graphs & Traversal Methods: The method may be applied for arbitrary tree or graph data structures and traversal strategies.

In an embodiment, a computer generates a multi-sequence vector that contains a plurality of distinct sequences of distinct nodes of a parse tree of source logic. Based on the multi-sequence vector, the computer trains a logic encoder. After training and in a production environment, the logic encoder infers a fixed-size encoded logic from new source logic. Based on the fixed-size encoded logic, the new source logic is detected as anomalous by an anomaly detector. Both of the logic encoder and the anomaly detector are machine learning models and, herein, they may be separately trained. In an embodiment, the logic encoder is based on a natural language processing (NLP) language model architecture such as bidirectional encoder representations from transformers (BERT), or novel training herein may be self-supervised according to skip-gram for use with an unlabeled training corpus.

### 1.0 Example Training Computer

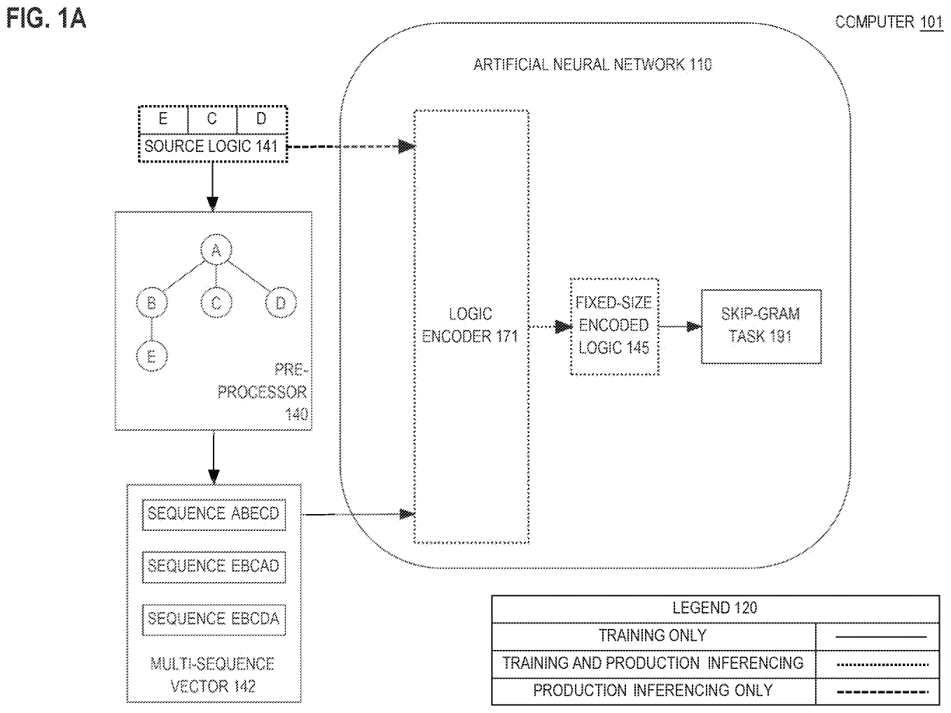

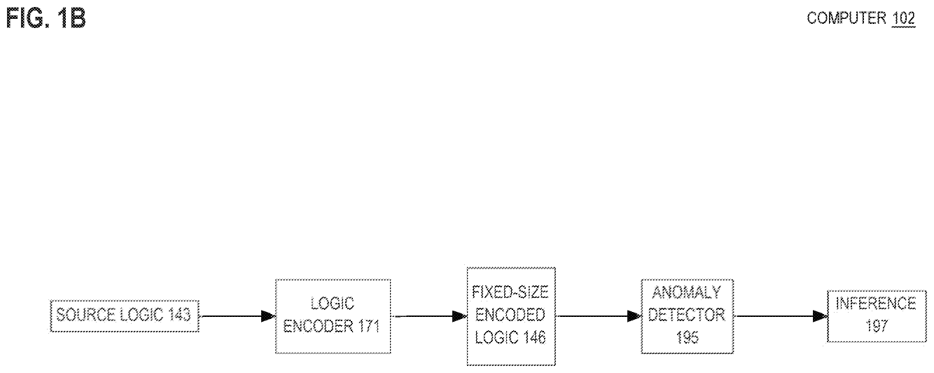

FIG. 1A is a block diagram that depicts an example training computer 101. In an embodiment, computer 101 uses natural language processing (NLP) skip-gram task 191 to train logic encoder 171 in artificial neural network (ANN) 110 to infer fixed-size encoded logic 145 from source logic 141. Computer 101 may be one or more of a rack server such as a blade, a personal computer, a mainframe, or a virtual computer.

Source logic 141 is text that contains one or more logic statements for a formal computer language such as a scripting language such as python or JavaScript, for a general purpose programming language such as C++ or Java, or for a database language such as structured query language (SQL). For example, source logic 141 may be a python script in a text file in a filesystem, a C++ source file, dynamically received or generated JavaScript in a web browser, or a database statement received in a database session such as with open database connectivity (ODBC) or Java ODBC (JDBC).

### 1.1 Logic Encoder

Logic encoder 171 is multiple neural layers in ANN 110. ANN 110 is used as a training harness to train logic encoder 171. In the shown embodiment, skip-gram task 191 may be a single neural layer in ANN 110 that provides a self-supervised training goal (i.e. objective) for ANN 110. Although computer 101 is for training, logic encoder 171 may operate during training and production inferencing. Legend 120 demonstratively indicates which components in training computer 101 will be retained for production use. Training components 110, 140, 142, and 191 are shown with a solid outline to indicate that these components are for training only and are unused and may be absent during production inferencing. Components 141, 171, and 145 are shown with a dotted outline to indicate that these components may operate during training and during production inferencing, which also is shown in later FIG. 1B.

Computer 101 can tokenize source logic 141 into a variable-length sequence of lexical tokens E, C, and D as shown that logic encoder 171 could, in some examples, accept as input during production inferencing, but not during training of ANN 110. The arrow that extends from source logic 141 to logic encoder 171 is shown dashed that, according to legend 120, indicates that logic encoder 171 accepts as input the original sequence of tokens (e.g. E, C, D as shown) that occur in any source logic only during production inferencing.

The arrow that extends from multi-sequence vector 142 to logic encoder 171 is shown solid that, according to legend 120, indicates that logic encoder 171 instead accepts, as input during training, a different token sequence that is not the original sequence of tokens that occur in a source logic.

For example, source logic 141 could be processed as shown during training or during production inferencing, but the token sequence that logic encoder 171 receives as input that represents source logic 141 will be different depending on whether training or production inferencing is occurring. During production inferencing for source logic 141, the token sequence would be E, C, D as shown. During training, the token sequence may reorder the tokens from the original sequence and may insert additional tokens that do not occur in the original sequence. Thus, multi-sequence vector 142 may be a token sequence that is longer than the original sequence and contains more kinds of tokens to convey more training information into logic encoder 171 as discussed later herein.

During training, skip-gram task 191 withholds (i.e. skips, obscures by masking) one or more tokens of source logic 141 that, within the sequence of tokens of source logic 141, occur within a small distance (e.g. a span of one to four tokens) from a current token. Classic skip-gram predicts multiple tokens (e.g. words) surrounding a current token. In various embodiments, ANN 110 has a different training task that is not skip-gram task 191, may have a different objective function, and may be supervised, unsupervised, or self-supervised. For example, BERT has its own training task that is not skip-gram task 191 and, if logic encoder 171 is based on BERT, then that training task is used instead of skip-gram task 191. FastText has its own training task that is shown as skip-gram task 191, which may be FastText's variant of skip-gram as follows.

If logic encoder 171 is based on FastText, the training task is a continuous bag of words (CBOW) model, and the training objective is to predict the target word (i.e. token) based on the context words surrounding it. In the CBOW model, FastText considers a fixed-size window of context words and aims to predict the target word in the center of that window. For example as shown, source logic 141 is a sequence of tokens E, C, D. If the size of the sliding window is three, then the window may slide to contain all three tokens E, C, D. CBOW withholds the center token C, which skip-gram task 191 trains to predict based on surrounding tokens E and D that are not withheld. The mechanisms of CBOW and withholding are discussed below.

### 1.2 Training Architecture

The following is a non-limiting example way to train ANN 110. Training ANN 110 is self-supervised because the correct inference (i.e. center token) by skip-gram task 191 is already known to computer 101 based on the current position of CBOW's sliding window within source logic 141. In other words, skip-gram task 191 infers a missing token, and inferring an incorrect token is a measurable error. By neural backpropagation, training error is used to adjust neural weights in neural components 110, 171, and 191 to cause increased accuracy by representation learning. In other words, skip-gram task 191 provides feedback that trains logic encoder 171 to more accurately infer fixed-size encoded logic 145.

Skip-gram task 191 accepts novel training input that is based on multi-sequence vector 142, Although source logic 141 is shown as demonstratively containing only tokens E, C, D, in practice source logic 141 likely contains tens or hundreds of tokens. In that case, source logic 141 is likely to be much longer than CBOW's sliding window.

### 1.3 Multi-Sequence Vector

Skip-gram task 191 accepts novel training input that is based on multi-sequence vector 142, Although other embodiments may use multi-sequence vector 142 in a production environment for increased accuracy, in this embodiment multi-sequence vector 142 is generated for training only. However, training input for logic encoder 171 is an augmentation of non-training (i.e. production) input. In production as discussed earlier herein, the arrow that extends from source logic 141 to logic encoder 171 is shown dashed to indicate that logic encoder 171 accepts as input the original sequence of tokens (e.g. E, C, D as shown) that occur in any source logic only during production inferencing.

Thus in production, logic encoder 171 accepts a sequence of tokens generated by tokenizing source logic 141. This tokenization is lexical, not syntactic. In other words, the token sequence may be generated by a scanner or lexer in a production computer. Because syntax is unneeded to generate the sequence of tokens E, C, D from source logic 141's raw text, a parser is not used to generate the token sequence in production, which means that the production token sequence does not expressly contain dependencies between tokens. Generating the production token sequence does not entail an abstract syntax tree (AST) nor any other kind of parse tree.

However, multi-sequence vector 142 is generated from a parse tree such as an AST. Training preprocessor 140 generates the shown parse tree that contains tree nodes A-E. Typically, leaf (i.e. terminal) nodes C-E represent literals that source logic 141 expressly contains. Typically, non-terminal nodes are implied by the structure of source logic 141 that is not expressly represented before parsing by preprocessor 140. Only leaf nodes C-E occur in the production sequence of tokens E, C, D, and non-terminal nodes do not occur in the production token sequence.

In the state of the art, a machine learning model (e.g. ANN 110) cannot directly accept a parse tree as input due to feature engineering concerns. For example, a parse tree typically lacks a high-fidelity (i.e. non-lossy) dense encoding, and a sparse encoding decelerates training and decreases accuracy. These feature engineering concerns are satisfied by multi-sequence vector 142 that is a novel and efficient encoding of a parse tree that, as an encoding, is only slightly lossy. Multi-sequence vector 142 encodes most of the topology of the parse tree and thus is highly accurate.

Multi-sequence vector 142 contains multiple sequences that each enumerate nodes A-E of the parse tree in a different ordering. Each of nodes A-E is represented as a respective token in each sequence in multi-sequence vector 142. For demonstration, the sequences are identified according to their respective orderings. For example, sequence ABECD orders the tokens of the tree nodes as A, B, E, C, and D.

Although non-terminal tree nodes do not occur as tokens in the production token sequence, non-terminal tree nodes A-B do occur as tokens in multi-sequence vector 142. Each sequence in multi-sequence vector 142 contains all of tokens A-E exactly once, but in orderings that usually are distinct. This approach still succeeds even if occasionally some orderings are redundant (i.e. not distinct).

### 1.4 Tree Traversal

How many sequences does multi-sequence vector 142 contain and which heuristics are used for generating the different orderings in the different sequences depends on the embodiment. The shown embodiment has the following example sequences. Sequence ABECD is generated by a preorder traversal of the parse tree. Sequence EBCAD is generated by an in-order traversal of the parse tree. Sequence EBCDA is generated by a post-order traversal of the parse tree. In an embodiment none or only some of the sequences are based on tree traversals. In the shown embodiment, none of the tree traversals are based on random walking nor random sampling.

In this example, each of the shown three traversal sequences is distinct. For example, there is only one shown sequence that both begins with token E and ends with token D. As shown, there is only one sequence that begins with token A. There is only one shown sequence that ends with token A.

### 1.5 TREE TOPOLOGY REPRESENTATION

Multi-sequence vector 142 contains structural information based on parsing during training that does not occur in the unparsed production token sequence that logic encoder 171 accepts as input in production. This structural information is based on the topology of the parse tree, including concerns such as nesting. For example, source logic 141 may contain an expression such as V+U*W that cannot be conclusively analyzed without knowledge that multiplication takes precedence over addition, which is knowledge that is captured in a parse tree but not captured in the production token sequence that logic encoder 171 accepts in production. Topological concerns such as precedence are encoded in multi-sequence vector 142.

For example, shown tree edges (e.g. links, references, memory address pointers, or array offsets) interconnect tree nodes A-E. Each tree edge connects two distinct tree nodes, and those two nodes are adjacent in at least one of the sequences in multi-sequence vector 142. For example, tree nodes A-B are connected by a tree edge, and tokens A-B are adjacent in sequence ABECD. Two vertices connected by an edge may be represented by adjacent tokens in as many as all of the sequences in multi-sequence vector 142. For example, nodes B and E are connected by an edge, and tokens B and E are adjacent in all of sequences ABECD, EBCAD, and EBCDA.

Thus, training uses input that may be both lexical and syntactic, whereas production uses only lexical input. Due to having more and better input, skip-gram task 191 provides more accurate training feedback for training logic encoder 171 during backpropagation through ANN 110. Skip-gram task 191 is self-supervised and can be used with an unlabeled training corpus that contains source logic 141.

As discussed earlier herein, the sequence of tokens E, C, D in source logic 141 is accepted as production input by logic encoder 171 in production. In other words, logic encoder 171 is designed to accept as input a token sequence that may contain a variable count of tokens. Variable-size input into logic encoder 171 is a flexibility that facilitates augmenting the token sequence with additional (e.g. synthetic such as non-terminal nodes) tokens to provide additional (e.g. syntactic) information via multi-sequence vector 142.

As discussed earlier herein, most embodiments use multi-sequence vector 142 only in training, but some embodiments may also use multi-sequence vector 142 in production. In that case in production instead of accepting production sequence E, C, D, logic encoder 171 accepts an augmented token sequence that is a concatenation of all of sequences ABECD, EBCAD, and EBCDA. For example, token B occurs three times in the augmented sequence. In that embodiment, logic encoder 171 accepts the entire multi-sequence vector 142 (i.e. all of its multiple sequences) as a sole input.

In the shown embodiment, multi-sequence vector 142 is used only for training. If FastText CBOW training is used, the sliding window slides over each of sequences ABECD, EBCAD, and EBCDA. The window start at the beginning of one of those sequences and, upon reaching the end of that sequence, starts sliding over the next sequence until the window has slid over all sequences in multi-sequence vector 142.

In this example, the window size is three tokens, which is two neighboring tokens and the withheld center token. For example, the window of sequence ABECD may contain tokens A, B, E, in which case token B is the withheld center token. The two neighboring tokens A and E are provided to logic encoder 171 as an input sequence having only two tokens A, E, which causes logic encoder 171 to infer (i.e. generate) fixed-size encoded logic 145 that skip-gram task 191 accepts as input.

In that way, logic encoder 171 can accept as input a training sequence of two tokens A, E that: a) is shorter than source logic 141's original (e.g. production) sequence of three tokens E, C, D and b) contains non-terminal token A that the production sequence does not contain. Thus in the shown embodiment, logic encoder 171 does not accept the entire multi-sequence vector 142 as input, but instead accepts only the few tokens in a current window (i.e. segment) of only the one sequence in multi-sequence vector 142 over which the window currently slides.

When a training embodiment has both of components 142 and 191: a) each training input token sequence is shorter (i.e. two tokens in this example) than the original token sequence (i.e. three tokens in this example) of source logic 141, and b) as the window slides over the current sequence in multi-sequence vector 142, multiple training sequences of input tokens are generated. For example after generating a first training input sequence A, E whose withheld center token is B, the window slides such that token E becomes the withheld center token for generating a second training input sequence B, C.

Although not shown, skip-gram task 191 responsively infers (i.e. predicts) the withheld token. If the inferred token is incorrect (i.e. not token B), then training error is measured and backpropagated through neural components 110, 171, and 191 as discussed herein. In that way, logic encoder 171 learns to more accurately encode any token sequence.

Logic encoder 171 can generate fixed-size encoded logic 145 from any token sequence in training or production. The token sequence can be original or augmented, can contain synthetic (e.g. non-terminal) tokens or not, can contain one or more instances (i.e. duplicates) of any original token or not, can have token(s) withheld or not, can have tokens reordered or not, and can have the sequence clipped (e.g. by a window) or not. Those sequence variations may be needed to fulfil various training or production task(s) that are downstream of logic encoder 171, such as skip-gram task 191, and the downstream task(s) accept fixed-size encoded logic 145 as input. However, none of those sequence variations are a concern of logic encoder 171 that will infer a respective instance of fixed-size encoded logic 145 for any input sequence.

For example as explained earlier herein, nodes C-E are terminal (i.e. leaf) nodes, and nodes A-B are non-terminal nodes. In the shown embodiment, none of sequences ABECD, EBCAD, and EBCDA contiguously encode all non-terminal nodes. That is, in each sequence in multi-sequence vector 142, terminal and non-terminal nodes are somewhat interleaved. For example, leaf nodes C-E are noncontiguous in all of sequences ABECD, EBCAD, and EBCDA. Those kinds of reordering and interleaving may cause other language models to malfunction or lose accuracy, whereas logic encoder 171 is a language model whose training accuracy increases with multi-sequence vector 142 due to increased syntactic information, and the increased accuracy in training is retained by logic encoder 171 even in production where multi-sequence vector 142 is not used.

### 1.6 Example Deployment Computer

FIG. 1B is a block diagram that depicts an example deployment computer 102. In an embodiment, computer 102 uses an already trained logic encoder 171 in a production environment to infer fixed-size encoded logic 146 from new source logic 143 as discussed earlier herein. Here, logic encoder 171 is deployed for production inferencing without the training harness discussed earlier herein. Computer 102 does not contain artificial neural network (ANN) 110.

In both of computers 101-102, logic encoder 171 is a same set of neural layers that may be deployed as its own neural network or embedded into a larger neural network such as shown in FIG. 1A, and FIG. 1B is discussed with reference to components of FIGS. 1A-1B. In FIG. 1B, logic encoder 171 may be its own neural network or may be embedded in a larger neural network that contains both of logic encoder 171 and anomaly detector 195, but only if anomaly detector 195 is neural. For example, anomaly detector 195 may be an autoencoder that is a multilayer perceptron (MLP) that is a neural network. Anomaly detector 195 may instead be a machine learning model such as a random forest that is not neural.

In an embodiment, logic encoder 171 may contain a natural language processing (NLP) model such as FastText or bidirectional encoder representations from transformers (BERT). In an embodiment (e.g. BERT), logic encoder 171 does not comprise an autoencoder, a recurrent neural network, nor a long short-term memory.

Source logic 143 may be a new (i.e. previously unseen) source logic that might have been created after logic encoder 171 was trained and deployed into production. Source logics 141 and 143 may be more or less dissimilar and may be tokenized in a same way that generates different respective token sequences. Distinct fixed-size encoded logics 145-146 may be inferred in a same way as discussed earlier herein.

Anomaly detector 195 accepts fixed-size encoded logic 146 as input to generate inference 197 that may be a binary anomaly classification or a numeric anomaly score such as a probability that is anomalous if exceeding a predefined threshold. Logic encoder 171 is already trained, but whether or not anomaly detector 195 is in training depends on the environment. The linear flow of components shown in FIG. 1B may occur in a laboratory to train anomaly detector 195 or may occur in production for inferencing only. In either case, logic encoder 171 is already trained.

### 2.0 Example Training and Inferencing Process

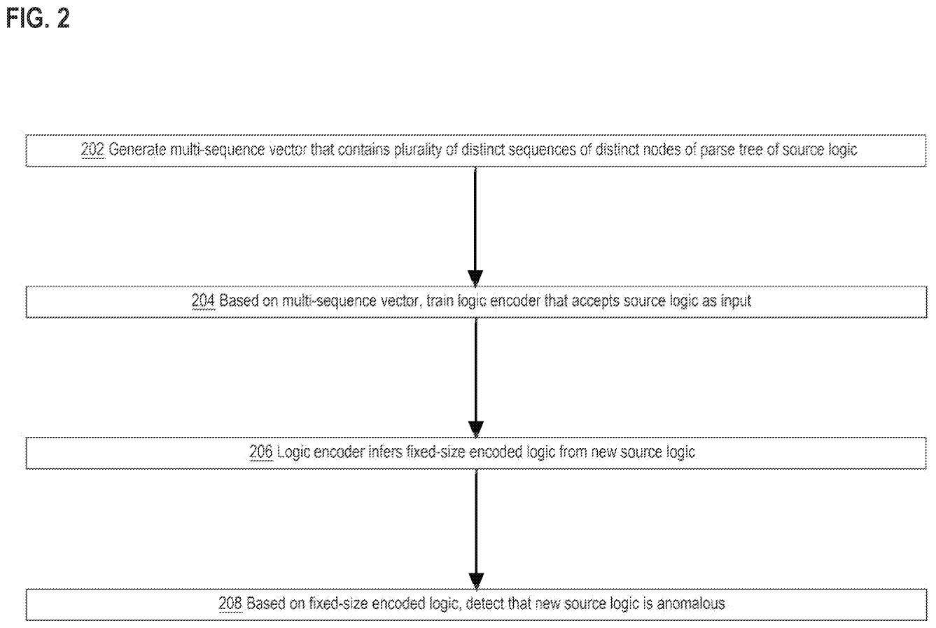

FIG. 2 is a flow diagram that depicts an example computer process to train and deploy, into production, logic encoder 171 to infer a fixed-size encoded logic from a source logic. As explained earlier herein, computers 101-102 respectively perform training and production inferencing. For example, training steps 202 and 204 may be performed by training computer 101, and inferencing steps 206 and 208 may instead be performed by computer 102. In an embodiment, computers 101-102 are a same computer.

Training steps 202 and 204 are discussed with reference to training FIG. 1A. Training step 202 generates multi-sequence vector 142 that contains distinct sequences ABECD, EBCAD, and EBCDA of distinct nodes A-E of the example parse tree of source logic 141 as shown within novel preprocessor 140 that may be software executed by computer 101. Sequence generation may or may not entail tree traversal as discussed for FIG. 1A.

In an embodiment, step 202 uses three distinct tree node iterators for three distinct traversals of the same parse tree. For example, a tree node iterator may implement a visitor design pattern to sequentially visit each node in the tree exactly once. As each node is visited, a token that represents the node may be appended into an array of tokens that is one token sequence in multi-sequence vector 142. One tree traversal to generate one distinct token sequence may be executed sequentially, which is one node and token at a time. The three distinct traversals of the same tree may concurrently occur for acceleration.

Based on multi-sequence vector 142, step 204 trains neural components 110, 171, and 191. Step 204 trains with multi-sequence vector 142 for source logic 141 as discussed earlier herein. Activities of step 204 may be repeated for each source logic in a (e.g. unlabeled) training corpus.

After step 204, logic encoder 171 is already trained and is used to train anomaly detector 195 of FIG. 1B. After anomaly detector 195 is trained, machine learning models 171 and 195 may be deployed into a production environment. Inferencing steps 206 and 208 occur while training anomaly detector 195, and steps 206 and 208 are repeated in a production environment after training. In training, new source logic 143 used for steps 206 and 208 may or may not be reused from the training corpus that was used for FIG. 1A.

In production, new source logic 143 of steps 206 and 208 is previously unseen because it was not used for training in FIG. 1A. In a production embodiment, machine learning models 171 and 195 are already trained. In inference step 206, logic encoder 171 infers fixed-size encoded logic 146 from new source logic 143 as discussed for FIG. 1B. Multi-sequence vector 142 is not used for inferencing steps 206 and 208. For example, multi-sequence vector 142 and the parse tree of FIG. 1A may be discarded immediately after training step 204. For example, computer 102 need not contain preprocessor 140 nor a parser.

In step 208 and based on fixed-size encoded logic 146, anomaly detector 195 generates inference 197 that is a detection that new source logic 143 is anomalous. In this example, inferencing step 208 and components 195 and 197 of FIG. 1B are parts of a downstream application that receives fixed-size encoded logic 146 as input for anomaly detection. In other examples, a different downstream application receives fixed-size encoded logic 146 as input for a different task that is not anomaly detection.

In other words, logic encoder 171 of FIG. 1B is a reusable component that is already trained and can be integrated for use in any downstream application. It does not matter which downstream application is integrated because, in any case, fixed-size encoded logic 146 has increased accuracy for representing source logic 143. Increased accuracy of fixed-size encoded logic 146 accelerates training and increases accuracy of any machine learning model (e.g. anomaly detector 195) in any downstream application.

In various embodiments, various production applications may be downstream of logic encoder 171 and may accepts as input fixed-size encoded logic 146 that logic encoder 171 emits. Instead of anomaly detector 195, an embodiment may have any of the following example downstream production applications that perform source code management:
Source code commit comment generation for source logic 143.
Predict when a commit is necessary such as when a revision and an original of source logic 143 differ too much.

An embodiment may have any of the following example downstream production applications that perform source code refactoring:
Method name generation when source logic 143 is the body of a method.
Clone detection or similarity detection of two source logics such as for consolidation by refactoring.

An embodiment may have any of the following example downstream production applications that perform test automation:
Unit test generation for source logic 143.
Test prioritization based on ranking how different are multiple revised source logics from their respective original source logics.

Some of the above downstream production tasks entail measuring a difference between two source logics or two versions of a same source logic. Fixed-size encoded logics herein may each be treated as a feature vector that is an array of numbers. Various multidimensional distance metrics such as Manhattan, Euclidian, or Mahalanobis may be used to measure a numeric distance magnitude between any two fixed-size encoded logics herein. This distance is a semantic distance. When two source logics differ little, the semantic distance between their respective fixed-size encoded logics is small.

In this example, source logic 143 may be a new database statement such as a SQL statement, and step 208 detects that the new database statement is anomalous. As discussed earlier herein, logic encoder 171 accepts a token sequence that is generated by tokenization that is an order of magnitude faster than parsing and can be done before parsing. In other words, inference steps 206 and 208 may occur before parsing source logic 143.

For example, step 208 detects that source logic 143 is anomalous, which may cause step 208 to decide to avoid computationally intensive activities such as parsing. Not parsing also means not execution planning and not statement execution. In another example, computer 102 is an end user's laptop or smartphone that hosts a web browser that contains and operates already trained machine learning models 171 and 195 of FIG. 1B, and step 208 detects that a webpage being loaded contains source logic 143 as JavaScript that is anomalous. In that case, step 208 may avoid parsing and executing the JavaScript.

Thus, step 208 may use inference 197 from anomaly detector 195 to avoid various processing of source logic 143 that is slow (i.e. computationally intensive) or dangerous. In that way, step 208 preserves computer resources such as time, memory, and secure data. Thus, step 208 accelerates and increases security of computer 102 itself.

### 3.0 Database Overview

Embodiments of the present invention are used in the context of database management systems (DBMSs). Therefore, a description of an example DBMS is provided.

Generally, a server, such as a database server, is a combination of integrated software components and an allocation of computational resources, such as memory, a node, and processes on the node for executing the integrated software components, where the combination of the software and computational resources are dedicated to providing a particular type of function on behalf of clients of the server. A database server governs and facilitates access to a particular database, processing requests by clients to access the database.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database comprises data and a database dictionary that is stored on a persistent memory mechanism, such as a set of hard disks. A database is defined by its own separate database dictionary. A database dictionary comprises metadata that defines database objects contained in a database. In effect, a database dictionary defines much of a database. Database objects include tables, table columns, and tablespaces. A tablespace is a set of one or more files that are used to store the data for various types of database objects, such as a table. If data for a database object is stored in a tablespace, a database dictionary maps a database object to one or more tablespaces that hold the data for the database object.

A database dictionary is referred to by a DBMS to determine how to execute database commands submitted to a DBMS. Database commands can access the database objects that are defined by the dictionary.

A database command may be in the form of a database statement. For the database server to process the database statements, the database statements must conform to a database language supported by the database server. One non-limiting example of a database language that is supported by many database servers is SQL, including proprietary forms of SQL supported by such database servers as Oracle, such as Oracle Database 11 g. SQL data definition language (“DDL”) instructions are issued to a database server to create or configure database objects, such as tables, views, or complex types. Data manipulation language (“DML”) instructions are issued to a DBMS to manage data stored within a database structure. For instance, SELECT, INSERT, UPDATE, and DELETE are common examples of DML instructions found in some SQL implementations. SQL/XML is a common extension of SQL used when manipulating XML data in an object-relational database.

A multi-node database management system is made up of interconnected nodes that share access to the same database. Typically, the nodes are interconnected via a network and share access, in varying degrees, to shared storage, such as with shared access to a set of disk drives and data blocks stored thereon. The nodes in a multi-node database system may be in the form of a group of computers, such as work stations and/or personal computers, that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

### 3.1 Query Processing

A query is an expression, command, or set of commands that, when executed, causes a server to perform one or more operations on a set of data. A query may specify source data object(s), such as table(s), column(s), view(s), or snapshot(s), from which result set(s) are to be determined. For example, the source data object(s) may appear in a FROM clause of a Structured Query Language (“SQL”) query. SQL is a well-known example language for querying database objects. As used herein, the term “query” is used to refer to any form of representing a query, including a query in the form of a database statement and any data structure used for internal query representation. The term “table” refers to any source object that is referenced or defined by a query and that represents a set of rows, such as a database table, view, or an inline query block, such as an inline view or subquery.

The query may perform operations on data from the source data object(s) on a row by-row basis as the object(s) are loaded or on the entire source data object(s) after the object(s) have been loaded. A result set generated by some operation(s) may be made available to other operation(s), and, in this manner, the result set may be filtered out or narrowed based on some criteria, and/or joined or combined with other result set(s) and/or other source data object(s).

A subquery is a portion or component of a query that is distinct from other portion(s) or component(s) of the query and that may be evaluated separately (i.e., as a separate query) from the other portion(s) or component(s) of the query. The other portion(s) or component(s) of the query may form an outer query, which may or may not include other subqueries. A subquery nested in the outer query may be separately evaluated one or more times while a result is computed for the outer query.

Generally, a query parser receives a query statement and generates an internal query representation of the query statement. Typically, the internal query representation is a set of interlinked data structures that represent various components and structures of a query statement.

The internal query representation may be in the form of a graph of nodes, each interlinked data structure corresponding to a node and to a component of the represented query statement. The internal representation is typically generated in memory for evaluation, manipulation, and transformation.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

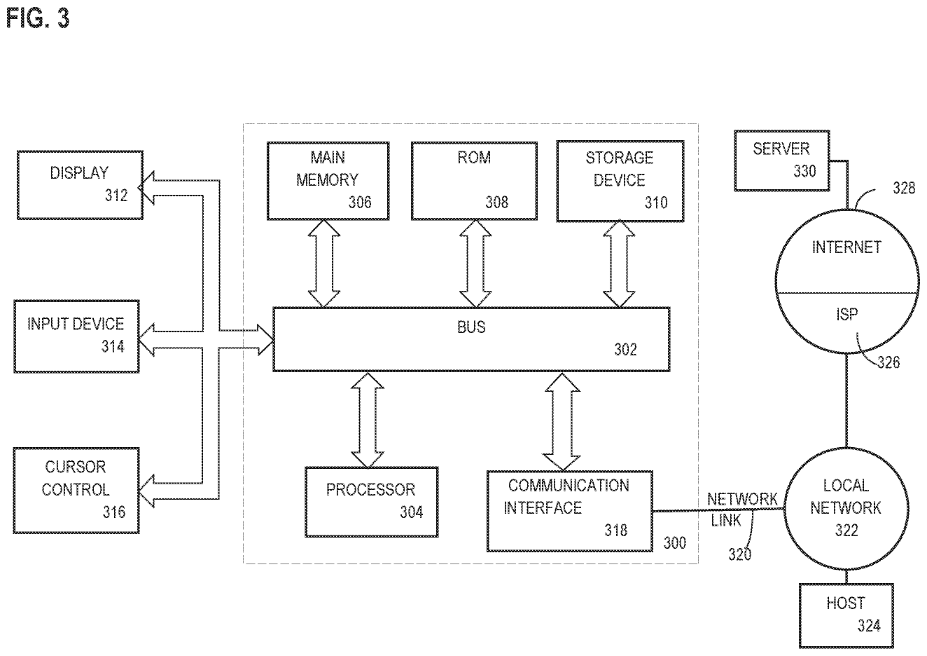

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

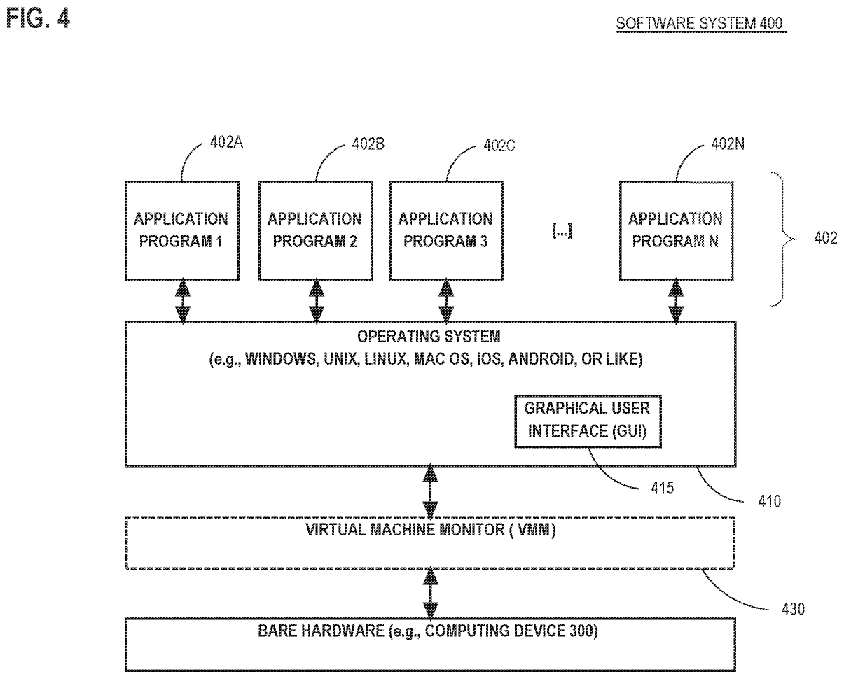

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 300 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al. PRINCIPAL COMPONENT ANALYSIS

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating a multi-sequence vector that contains a plurality of distinct sequences of distinct nodes of a parse tree of source logic;
training, based on the multi-sequence vector, a logic encoder;
inferring, by the logic encoder, a fixed-size encoded logic from a new source logic; and
detecting, based on the fixed-size encoded logic, that the new source logic is anomalous.

2. The method of claim 1 further comprising generating each sequence of the plurality of distinct sequences of distinct nodes of the parse tree by a respective distinct traversal of the parse tree.

3. The method of claim 1 wherein the plurality of distinct sequences of distinct nodes of the parse tree contains at least three distinct sequences.

4. The method of claim 1 wherein:
the source logic comprises one or more database statements;
the method further comprises based on said detecting that the new source logic is anomalous, not execution planning for the one or more database statements and not executing the one or more database statements.

5. The method of claim 1 wherein:
said training the logic encoder comprises self-supervised training;
copying, after said training the logic encoder, the logic encoder into a new neural network;
training the new neural network to detect whether source logic is anomalous, wherein the training the new neural network is not self-supervised.

6. The method of claim 1 wherein:
generating a neural network that can accept the source logic and the plurality of distinct sequences of distinct nodes of the parse tree as input, wherein the neural network contains said logic encoder;
self-supervised training the neural network to predict skipped tokens, wherein the self-supervised training the neural network comprises training the logic encoder;
deploying, after the training the logic encoder, the logic encoder without the neural network.

7. The method of claim 1 wherein:
the parse tree of the source logic contains a plurality of edges that interconnect said distinct nodes of the parse tree;
for each edge in the plurality of edges:
the edge connects two distinct nodes of the parse tree, and
the two distinct nodes are adjacent in at least one sequence in said plurality of distinct sequences.

8. The method of claim 7 wherein said at least one sequence in said plurality of distinct sequences is said plurality of distinct sequences.

9. The method of claim 1 further comprising based on said detecting that the new source logic is anomalous, not parsing the new source logic.

10. The method of claim 1 wherein:
said distinct nodes of the parse tree consists of a plurality of terminal nodes and a plurality of non-terminal nodes;
the plurality of terminal nodes are not entirely contiguous in each sequence of the plurality of distinct sequences.

11. The method of claim 1 wherein the logic encoder does not accept the entire multi-sequence vector as a single input.

12. One or more non-transitory computer-readable media storing instructions that, when executed by one or more processors, cause:
generating a multi-sequence vector that contains a plurality of distinct sequences of distinct nodes of a parse tree of source logic;
training, based on the multi-sequence vector, a logic encoder;
inferring, by the logic encoder, a fixed-size encoded logic from a new source logic; and
detecting, based on the fixed-size encoded logic, that the new source logic is anomalous.

13. The one or more non-transitory computer-readable media of claim 12 wherein the instructions further cause generating each sequence of the plurality of distinct sequences of distinct nodes of the parse tree by a respective distinct traversal of the parse tree.

14. The one or more non-transitory computer-readable media of claim 12 wherein the plurality of distinct sequences of distinct nodes of the parse tree contains at least three distinct sequences.

15. The one or more non-transitory computer-readable media of claim 12 wherein:
the source logic comprises one or more database statements;
the instructions further cause based on said detecting that the new source logic is anomalous, not execution planning for the one or more database statements and not executing the one or more database statements.

16. The one or more non-transitory computer-readable media of claim 12 wherein:
said training the logic encoder comprises self-supervised training;
copying, after said training the logic encoder, the logic encoder into a new neural network;
training the new neural network to detect whether source logic is anomalous, wherein the training the new neural network is not self-supervised.

17. The one or more non-transitory computer-readable media of claim 12 wherein:
generating a neural network that can accept the source logic and the plurality of distinct sequences of distinct nodes of the parse tree as input, wherein the neural network contains said logic encoder;
self-supervised training the neural network to predict skipped tokens, wherein the self-supervised training the neural network comprises training the logic encoder;
deploying, after the training the logic encoder, the logic encoder without the neural network.

18. The one or more non-transitory computer-readable media of claim 12 wherein:
the parse tree of the source logic contains a plurality of edges that interconnect said distinct nodes of the parse tree;
for each edge in the plurality of edges:
the edge connects two distinct nodes of the parse tree, and
the two distinct nodes are adjacent in at least one sequence in said plurality of distinct sequences.

19. The one or more non-transitory computer-readable media of claim 12 wherein the instructions further cause based on said detecting that the new source logic is anomalous, not parsing the new source logic.

20. The one or more non-transitory computer-readable media of claim 12 wherein the logic encoder does not accept the entire multi-sequence vector as a single input.
